(19) United States
(12) Patent Application Publication
(10) Pub. No.: US 2018/0278157 A1
(43) Pub. Date: Sep. 27, 2018

(54) DIRECT CURRENT POWER CONTROLLER

(71) Applicant: BLUE WOLF ENTERPRISES, INC, GARDEN CITY, ID (US)

(72) Inventors: TY PLOWMAN, GARDEN CITY, ID (US); DENNIS SAND, GARDEN CITY, ID (US)

(21) Appl. No.: 15/468,857

(22) Filed: Mar. 24, 2017

(51) Int. Cl. H02M 3/04; G05B 15/02

(52) U.S. Cl. CPC H02M 3/04; G05B 15/02

(57) ABSTRACT

What is disclosed is a DC power controller capable of regulating power across a plurality of DC power output channels in response to a user defined output curve. The amount of power generated per channel is determined by a single signal input utilized by a processor in DC power controller to determine the position on the user defined output curve where each DC power output is set forth for each channel.

### TECHNICAL FIELD

The presently disclosed technology relates to a direct current (DC) power controller. More particularly, the presently disclosed technology is a DC power controller capable of distributing power from a power input to two or more DC power output channels in accordance with two or more user defined power output curves.

### BACKGROUND

Power controllers in DC applications generally utilize an input of power and one or more power output channels. Typically one or more DC power using devices, such as a series of lights, are located on the same channel or on separate channels but each controlled by a single power controller, such as a dimmer per channel. A user utilizes the dimmer, typically in-line with the circuit, to directly control the power going to the series of lights. However this can create a situation in which lights which receive the same power input produce different output. An example of such a scenario exists when LED lights and incandescent lights receive the same power input: each light produces a different lumen output in response to the same power input.

In retrofit or new designs, mixing incandescent and LED lights is particularly an issue because it may not be possible to install all lights of one type. One bulky solution is to add multiple dimmers to each of the lighting circuits; however, doing so results in several full-sized power dimmers requiring frequent or constant individualized adjustments. The same concept applies to DC power regulating units that regulate other DC power driven applications including, but not limited to, seat heaters or blower motors in that multiple dimmers are required in order to control the power going to each device.

Accordingly, what is needed is a DC power controller that allows system designers to skew the voltage outputs between channels and that provides a simple, space saving, and single unit system for easy balancing of dissimilar power use zones, including lighting zones, in accordance with a user's input.

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

What is disclosed is a DC power controller having at least one DC power input, a plurality of DC power output channels, two or more power regulators for regulating power output from the DC power input to the DC power output channels, and a processor configured to control the power regulators and thus to regulate the power output of the DC power output channels.

The processor is configured to control the DC power output of the DC power controller according to one or more user defined power output curves stored in the DC power controller. The user defined power output curves are configured such that power output in each channel in the series of output channels can be determined by a single input signal. A user inputs the signal using a signal input module such as a dimmer or potentiometer to direct the processor as to the location on the user defined power output curves from which the processor is to calculate the power output for one or more power output channels. Alternatively, the signal can be automatically generated by a sensor, switch or other signal input module.

The DC power controller has one or more signal input module connectors or ports for signal input modules to be connected to the DC power controller. The signal input modules provide a connection mechanism through which a signal input module sends one or more signals to the processor. The signal input modules when connected to the processor via the signal input module connectors are not in-line with the power circuit thus smaller wiring can be and typically is used to connect the signal input module to the processor. The signal input module can include a variety of signal input modules including, but not limited to, a potentiometer, a dimmer, a switch, and/or the applicant's encoder module.

The DC power controller can utilize one or more signal input modules and/or an encoder module developed by the applicant. The encoder module is generally a signal input module that is capable of virtually functioning as multiple signal input modules from a single physical unit. The encoder module utilizes a signal adjustment mechanism, such as a knob or dial that functions as a potentiometer, and a virtual signal input module selection mechanism.

The virtual signal input module selection mechanism is configured to select the virtual signal module that the processor is utilizing to adjust the DC power output to each DC power output channel. In a preferred embodiment this selection mechanism is a depression mechanism located in the dial or knob such that a user depresses the dial or knob to change which virtual signal input module is being utilized.

Alternatively, the signal input mechanism can be a sensor that senses an occurrence, such as a vehicle door opening and/or vehicle ignition, or lack of an occurrence, such as a vehicle door not opening after a given period of time, that sends a signal to the processor to utilize a position on the user defined power output curve for determining the power to be provided to each power output channel.

A plurality of signal input modules can be used in connection with the DC power controller. For example, a first and a second signal input module can be utilized such that the first signal input module can be configured to adjust the DC power output to two or more DC power output channels in response to a first user defined power output curve. The processor can be configured such that a second signal input module is used to adjust the DC power output to two or more other DC power output channels in response to a second user defined power output curve. A single input module can be utilized to control DC power output over multiple power output channels. However, typically a single DC power output channel can only be controlled by a single input module and a single user defined output curve.

In an example embodiment the DC power controller is utilized to control two or more lights via separate power output channels such that each light provides the same lumen output in response to a signal from a signal input module. In order to accomplish this, the user defined power output curve applicable to each channel is configured such that in response to the signal, the power supplied to each light is determined such that the lumen output of each light is the same. If the user intends to change the lumen output of the lights, the user utilizes the signal input module, for example by rotating the dial of a potentiometer, which sends a new or second signal to the processor. The processor then looks up on the user defined power output curve the user defined amount of power to supply to each power output channel, and directs the power regulator to each channel to allow for the power output defined by the user defined power output curve.

Further example uses of the DC power controller include coordinating the power output across channels to coordinate power supplied to a variety to DC power using devices, including, but not limited to, incandescent lights, LED lights, heater pads, and blower motors.

An example of an embodiment of the DC power controller is utilizing a first DC power output channel on the DC power controller to control one or more day lights and having a second DC power output channel to control one or more night vision compatible lights. Day lights are defined as lights for use without night vision allowing devices. The processor can be configured to supply power to the one or more day lights and not to supply power to one or more night vision compatible lights upon receiving a first signal from the signal input module. The processor is configured to supply power to the one or more night vision compatible lights and not to supply power to the one or more day lights upon receiving a second signal from said signal input module. This embodiment may be particularly useful for military or law enforcement operations.

As a further example, the DC power controller can be connected via a first DC power output channel to one or more incandescent lights. A second DC power output channel is connected to one or more LED lights. Each channel in this example utilizes a separate power regulator controlled by the processor. The user defined power output curves can be inputted by the user such that when the processor receives a signal from a signal input module, the user defined power output curves direct the processor to control the power output of the power regulators to provide an amount of power that allows for the lumen output of the incandescent light channel and the LED light channel to be equivalent. While in the example given the lumen output is equivalent, the power supply and thus the lumen output of each channel can be set at whatever value the user desires. The user defined power output curves provide further guidance to the processor as to how to change the power output per power output channel in response to further or different signal provided by the signal input module. Thus if a user turns the dial of a potentiometer acting as the signal input module, the user defined power output curves provide the processor with reference for determining how much power to output at each channel in response to the change in signal generated by the user changing the position of the dial of the potentiometer.

Multiple power output channels can be controlled by the same power controller in order to produce the same power distribution to each power output channels. To provide different power output to separate power output channels, the power output channels are controlled by separate power controllers that are controlled by the processor.

In a preferred embodiment the user defined power output curves define a curve of power output per channel (or across multiple channels) based on the signal from the signal input module. For example, a user could define the power output curve as being anywhere from 0% to 100% or any subset of percentages therein. The user would next configure the power output in response to a second signal, which could be set between 0% and 100%. It is important to note that there can be a limitless number of signal calibrations calibrating a limitless number of power output channels and the terms 0% to 100% are used without any intention of limiting the invention to this embodiment. It is not necessary that the first point be at 0% but instead the first point could begin at, for example, 20% or 40%.

Further, it is particularly important to note that when a sensor is used as a signal input module, the processor can feature an input threshold mode. In the input threshold mode the processor is configured to allow the output of the same amount of power in response to variations in signals that are not sufficient enough to cause the processor to utilize a different point on the user defined output curve to determine the power output of the channel associated with the point. For example, the processor can be set such that a small vibration or tremor in the dial of a potentiometer does not alter the power supplied to each channel.

A user defined power output curve can be used by the processor to calculate the power output of a single power output channel or alternatively a user defined power output curve can be used to calculate the power output over a series of channels. As an example, the processor can be configured to control power output to a first power output channel and a second power output channel in response to a signal from a first signal input module connected to the processor. The processor can further be configured to control power output to a third power output channel and a fourth output channel in response to a signal from a second signal input module.

The DC power controller can include an optional display module. The display module can be configured to displayed, for example, the total power consumed for each of the DC power output channels either together or separately including a function of the amount of power consumed compared to the total power available.

Also disclosed is a method of using a DC power controller. The method of utilizing the DC power controller includes the step of providing a DC power controller. The DC power controller has at least one DC power input, a plurality of DC power output channels, and at least two power regulators configured to regulate the DC power output of at least two separate DC power output channels. The DC power controller utilizes at least one processor configured to control the power regulator associated with each channel and thus the DC power output of each channel. The processor uses a user defined power output curve to calculate the power output of each DC power output channel. To calculate the DC power output of each DC power output channel, the processor utilizes a signal generated by a signal input module or a lack of signal from the signal input module to calculate from the user defined power output curve the amount of power to direct the power regulator associated with each channel to output.

The disclosed method includes the step of programming two or more user defined power output curves into the DC power controller. The user defined power output curves are programmed by assigning a power output value to a first DC power output channel in response to a first signal input from the signal input module and programming a power output value to a second DC power output channel in response to the first input signal input from the signal input module. A second DC power output value is assigned to the first DC power output channel in response to a second input signal from the signal input module. A second DC power output value is assigned to the second DC power output channel in response to the second signal input from the signal input module. This step produces two DC power output channels that are controlled by two separate user defined power output curves. When a user sets a signal input module dial at a first location, the DC power output channels output power according to the user defined output curve. When the user, for example, turns the dial on a signal input module, the processor changes the power output by each DC power output channel according to the user defined power output curve associated with each respective channel.

In a preferred embodiment, the step of providing a DC power controller further includes providing a plurality of user defined power output curves. The method further including the step of providing a mechanism for a user to select which power output curve is utilized by the processor in regulating the DC power output to the plurality of DC power output channels in response to a user input signal.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1A illustrates the lumen output of an incandescent light in response to a linear power supply.

FIG. 1B illustrates the linear lumen output curve in response to a user defined power output curve according to the current inventive concepts.

FIG. 2 illustrates an embodiment of a DC power controller.

FIG. 3 illustrates a flow diagram of the logic of the DC power controller.

FIG. 4 illustrates a graph showing an example of a user defined power output curve controlling two or more output channels.

FIG. 5 illustrates a preferred embodiment of an expansion module compatible with the DC power controller.

FIG. 6 illustrates a flow diagram of the logic of a preferred embodiment of the logic control of the expansion module.

FIG. 7 illustrates a preferred embodiment of an encoder module.

FIG. 8 illustrates a preferred embodiment of a flow diagram of the logic control of the encoder module.

FIG. 9 illustrates a logic flow diagram of a preferred embodiment of the logic of control of the DC power controller in combination with an expansion module and an encoder module.

FIG. 10 illustrates a potential control schematic illustrating the control function of each signal input module in relation to the channel outputs of the processor.

FIG. 11 illustrates potential power output channels as controlled by the processor in relation to each signal input module and encoder module input of the depicted example.

FIG. 12 illustrates potential channel outputs as controlled by each example virtual signal input module input via an encoder module.

FIG. 13 illustrates an example of a series of power channel outputs of a DC power controller in association with an expansion module in response to signal input modules 1 and 2.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

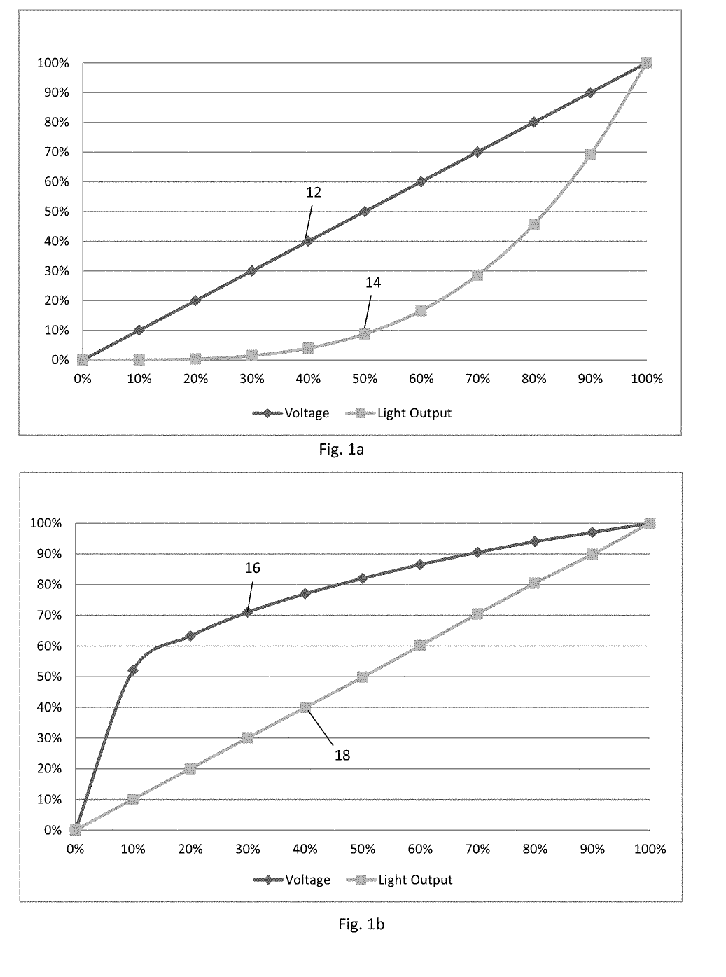

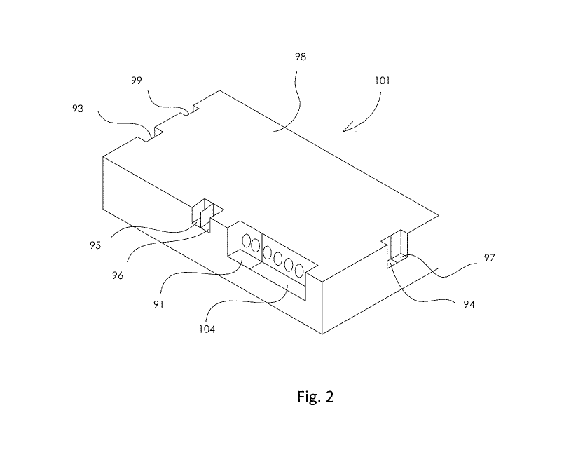

FIG. 1A illustrates the light output of an incandescent bulb 14 according to a traditional linear voltage input curve 12. As illustrated, as the power to the incandescent bulb increases, the lumen output of the incandescent bulb follows a generally exponential output curve. This is generally due to the principle that the incandescent bulb must heat up before it can reach maximum efficiency of lumen output versus power input.

FIG. 1B illustrates an example of a use of the DC power controller of the present inventive concepts. As illustrated, the input of power 16 to the incandescent light has been altered to produce a linear lumen output curve 18 for the incandescent light. Utilizing multiple user defined output curves for two or more different lights allows a user to define the power input to each light to obtain a predetermined, desired lumen output. For example, a user could configure two user defined output curves such that an LED light or series of LED lights on a first power output channel output the same lumen amount as an incandescent light or series of lights on a second power output channel in response to a single signal input module, such as a dimmer or potentiometer.

FIG. 2 illustrates a preferred embodiment of a DC power controller 101. The DC power controller in the illustrated embodiment includes a housing 98 having two power inputs 91 and four power output channels 104. The DC power input can be of a variety of voltages. For example, 28 volt direct current power can be utilized or alternatively 14 volts, 5 volts, 48 volts, or conceivably any supply of DC voltage could be used without departing from the inventive concepts disclosed therein. Within the DC power controller there exists one or more power regulators, which in a preferred embodiment are voltage regulators. In a preferred embodiment, these are 5 volt DC regulators (for the internal processor of the DC power controller). The processor can also have integral or other memory to store the operating algorithm of the DC power controller in the program memory of the device. The processor is configured to communicate with the other circuitry needed for generating the proper voltage output signals including the actual DC power control driver circuitry for each channel output. The DC power control reads or accepts the user's signal regarding where on a user configured power output curve the DC power controller is to be outputting DC power on each channel. This signal can be interpreted by the processor, signaling the processor as to the location on the user defined output curve the processor is to use to determine the power output for the associated power output channel. Two sample user defined output curves are illustrated at FIG. 4. The processor can also include a voltage protection device(s) and/or additional circuitry for converting the signal input of a user from a signal input module to an appropriate value that the processor can interpret.

In a preferred embodiment, the DC power controller includes a connector or port 93 via which a screen or similar device can be connected. This allows a user to input via the users laptop, tablet, or other device the user defined output curves.

The DC power controller can include an expansion module port 97 via which an expansion module can be added in a preferred embodiment. The DC power controller can be configured with any number of output channels. The power output channels in the depicted unit are four power output channels. In the depicted embodiment, when an expansion module is added, it can be used to increase the output channels to eight output channels. In a preferred embodiment the expansion module can also have two analog only outputs as well as the DC power output channels. It is to be noted that the number of channel outputs in the DC power controller and/or the expansion module are exemplary only, and each can be configured with any number of output channels that is consistent with the spirit of the invention.

The DC power controller can be configured with one or more signal input module connectors 94, 95, 96 via which a signal input module can be connected to the DC power controller. The signal input module can be, for example, a switch, a potentiometer, or a dimmer. The signal input module can further be any signal generating device from which the processor of the DC power controller can interpret a signal to determine the location on a user defined output curve that the processor should utilize to determine how to control the power output of each power output channel associated with the signal input module input port. For example, an encoder module developed by the applicant can be utilized as a signal control module capable of functioning virtually as multiple signal control modules and connects via a port 99 located in the housing of the DC power controller.

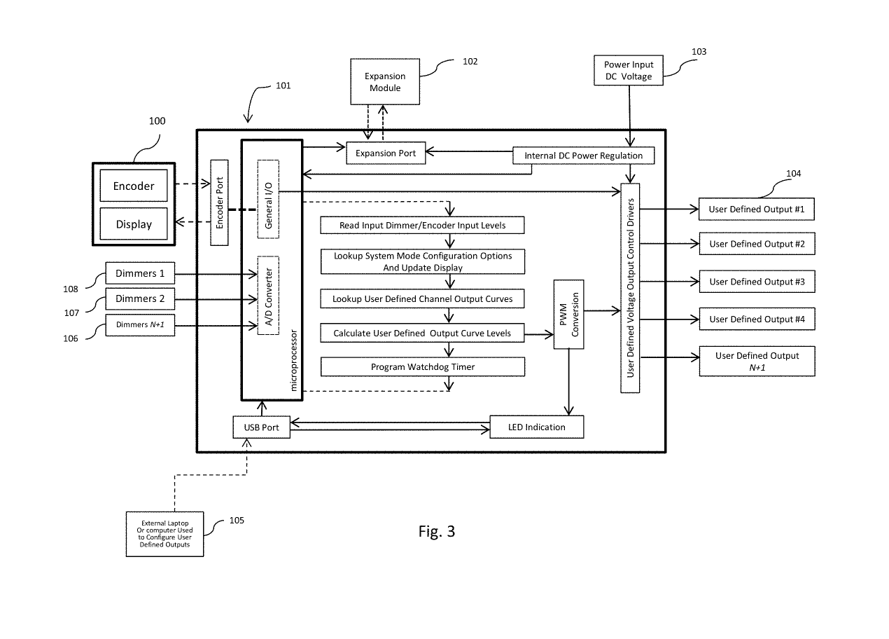

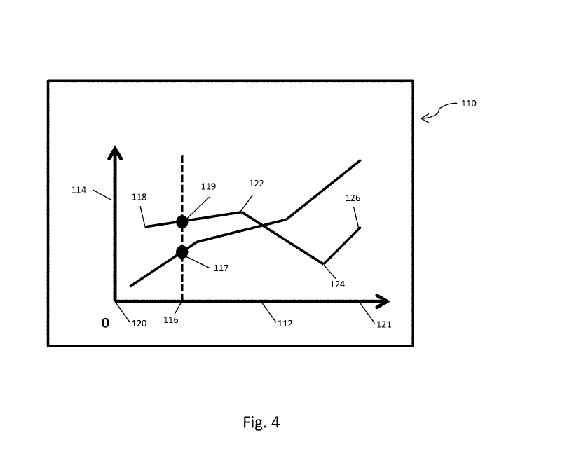

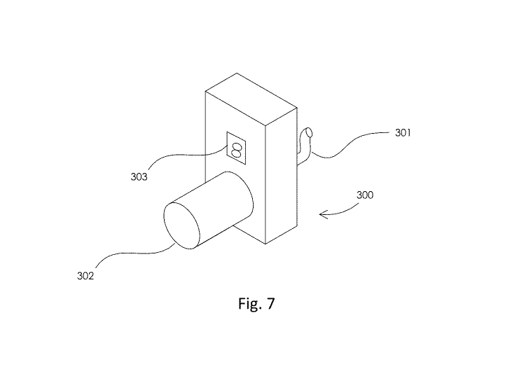

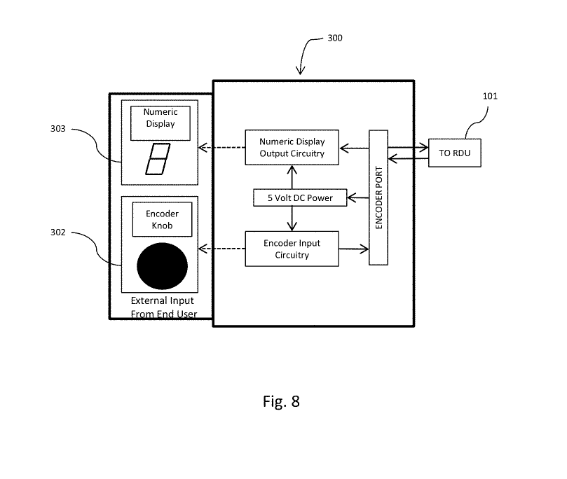

FIG. 3 illustrates the logic flow of the DC power controller 101 coordinating with an encoder module 100, signal input modules 106,107, 108, and expansion module 102. The DC power controller intakes DC power 103 and regulates the output of the power to a plurality of DC output channels 104. FIG. 3 illustrates possible signal input modules 106, 107, 108, communicating to the processor regarding the position on a user defined power output curve at which the power output per power output channel is to be calculated. FIG. 3 further illustrates the optional encoder module 100, if plugged into the encoder module port, that can function as a single signal input module or as multiple virtual signal input modules. The encoder module has the ability to function as multiple different signal input modules and the capability to inform the processor that it is a different signal input module, as discussed pertaining to FIGS. 7 and 8.

When the processor interprets a change in signal from a signal input module, the processor utilizes the input signal from the signal input module to look up the appropriate voltage output per DC power output channel on the user defined power output curve(s) to determine what the output power of each power output channel 104 should be in response to the signal the processor has received. The processor then controls the power regulator(s) associated with the power output channel to be controlled to provide an output power per channel as set forth by the user defined power output curve(s).

As illustrated in FIG. 3, the DC power controller can be configured with a port or similar plug by which a user can connect a laptop, tablet or similar device 105 to configure or install one or more user defined output curves onto the DC power controller. In a preferred embodiment, the external laptop or computer module is connected via a USB port that allows a user to set and control the user defined output curves.

FIG. 4 illustrates a chart 110 of two sample user defined output curves for two or more channels. The X-axis 112 sets a position on the curve when the input signal input module is at a given position 116 determined by the processor interpreting a signal from the signal input module. The Y-axis 114 is utilized for determining the power output of the channel at a given point. The intersection 120 of the x-axis and y-axis can be set at 0% output or it can begin at a different power output level or signal input module signal. In the illustrated example, the user defined power output curves terminate at value 121 on the x-axis illustrating, for example, a fourth position on a rotary dial. At this position the output of each curve can be set at any output number and is not limited to 100% as illustrated by the lower curve. At illustrated point 116, the power output of the first curve is at 117 and the power output of the second curve is at 119. The power control curves as illustrated have four points 118, 122, 124, and 126, at which the output is defined, although any number of points can be utilized to form a curve. At positions between these points in the depicted embodiment, the slope of the line between the points can be utilized to determine the output of the power of each channel.

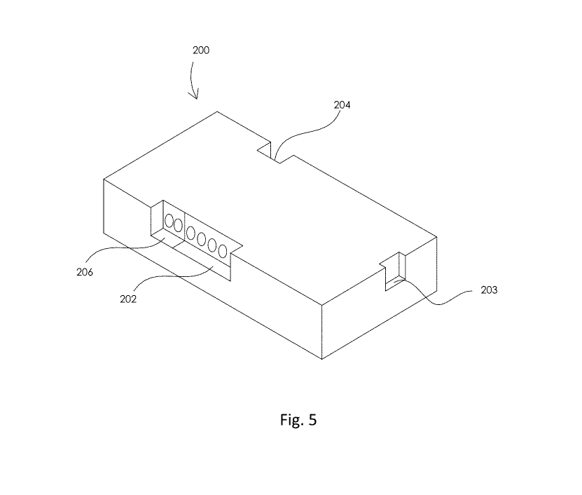

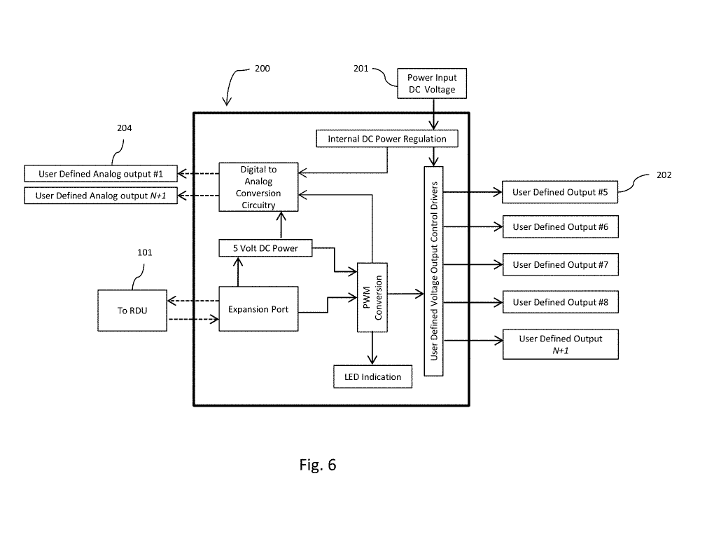

FIG. 5 illustrates a preferred embodiment of an expansion module 200. An expansion module can utilize its own separate external DC power source via DC power inputs 206 or it can utilize a power source direct from the DC power controller itself. The user defined output voltages are outputted through channels 202 from which they travel to the device being driven by the power including, but not limited to, lights, heater pads, blowers, or motors. The expansion module includes an expansion module port connector 203 via which the expansion module is connected to the DC power controller. The expansion module can include one or more analog power output channels 204 via which analog power is output after conversion from digital power by a converter located within the housing (see FIG. 6).

FIG. 6 illustrates the logic control of an expansion module. The expansion module includes a connection to the DC power controller. The expansion module includes DC power input 201 and internally regulates the power output of the DC power output channels of the expansion pack by one or more power regulators within the expansion module. The expansion module functions as an expansion of the DC power controller and thus utilizes the same methodology and structure discussed above for the DC power controller.

FIGS. 7 and 8 illustrate a preferred embodiment of the encoder module 300. The encoder module can serve as a single signal input module or as multiple virtual signal input modules. The encoder module of the depicted embodiment includes a knob or dial 302 that functions similar to a potentiometer dial. Rotation of the knob changes the signal that directs the processor as to the point on the user defined power output curves from which the processor is to calculate the power output per power output channel. In order to change which virtual signal input module the user is using the user can depress the knob 302 which will change the display number on the display screen 303. The displayed number is coordinated with the virtual signal input module the processor is to associate the signal generated by the dial of the encoder module. The encoder module is connected to the DC power controller via encoder module port 301. The encoder module utilizes the DC power provided by the DC power controller.

FIG. 8 depicts the logic flow of the encoder module. The encoder module connects to DC power controller (RDU) via the encoder module port. The encoder module receives DC power from the DC power controller via the encoder module port. The encoder module utilizes this DC power to provide the numeric display associated as well as to generate signal via the encoder module circuitry that is provide to the processor of the DC power control unit.

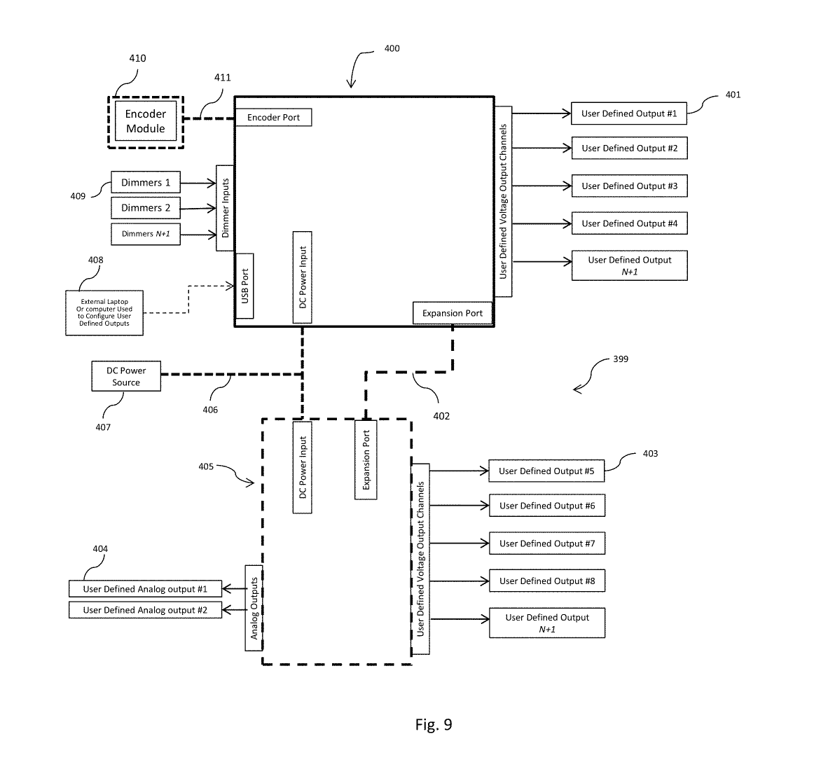

FIG. 9 is a logic diagram 399 illustrating the interaction of the DC power controller 400, encoder module 410, and expansion module 405. The DC power controller can utilize an encoder module 410 via encoder module input 411 or an alternative signal input module via input 411. Standard signal input modules such as dimmers 409 can be utilized to signal to the processors to control the DC power output of the DC power controller. In a preferred embodiment an external computer 408 and associated screen are utilized for a user to program and/or download a user defined output curve(s) to the DC power controller.

The expansion module can be configured either with a separate DC power source 406 or to utilize the same DC power source 407 as the DC power controller. The expansion module provides additional power output channels 403 in addition to the power output channels 401 of the DC power controller. It is important to note that the DC power controller can be built with any number of power output channels and that the expansion module can be utilized when an additional number of power output channels are desired. The DC power controller can utilize standard power output channels and/or it can utilize user defined analogue output channels 404. The expansion module is typically in connection with the DC power controller via a port connection 402. Optionally the expansion module conceivably includes additional signal input channels or ports.

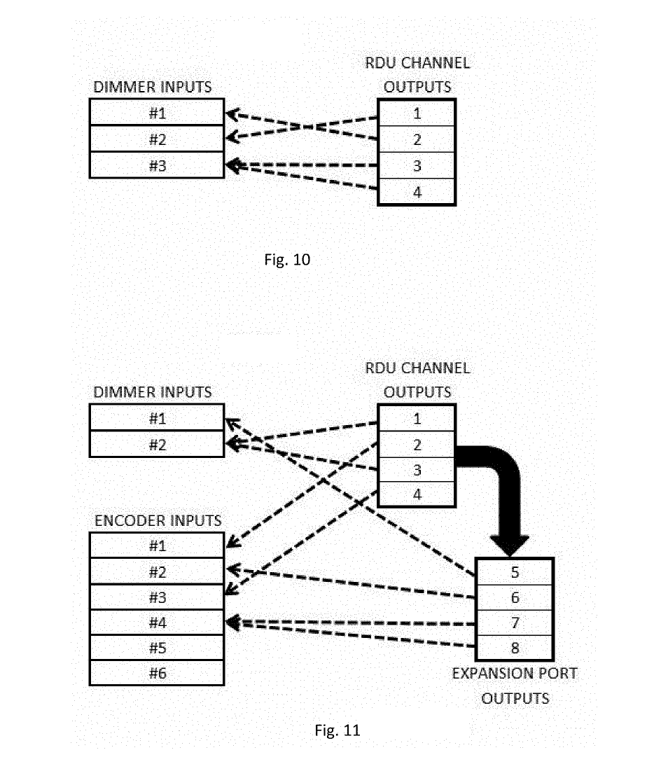

FIGS. 10-12 illustrate potential configurations of signal input module output control, controlling the power regulator to regulate power at a certain level to of a variety of channels. FIG. 10 illustrates the dimmer input, or signal input module 1, controlling directing the processor to control power output at channel output 2. Dimmer input 2 is controlling channel output 1. Dimmer input 3 is controlling channel output 3 and 4. As illustrated a single signal control module is utilized to control one or more output channels. However, each channel is only controlled by a single signal control module.

FIG. 11 illustrates its potential control scenario in which the DC power controller is used in association with the expansion module. The expansion module is providing additional channel outputs 5, 6, 7 and 8. A signal input module designated as 2 is utilized to control power output of channels 1 and 3 through via input 2 whereas signal control module 1 is utilized to control channel 5. A depicted encoder module is being utilized in a series of inputs to control individual channels or a combination of channels in both the RDU channel output, as well as the expansion module power output channels.

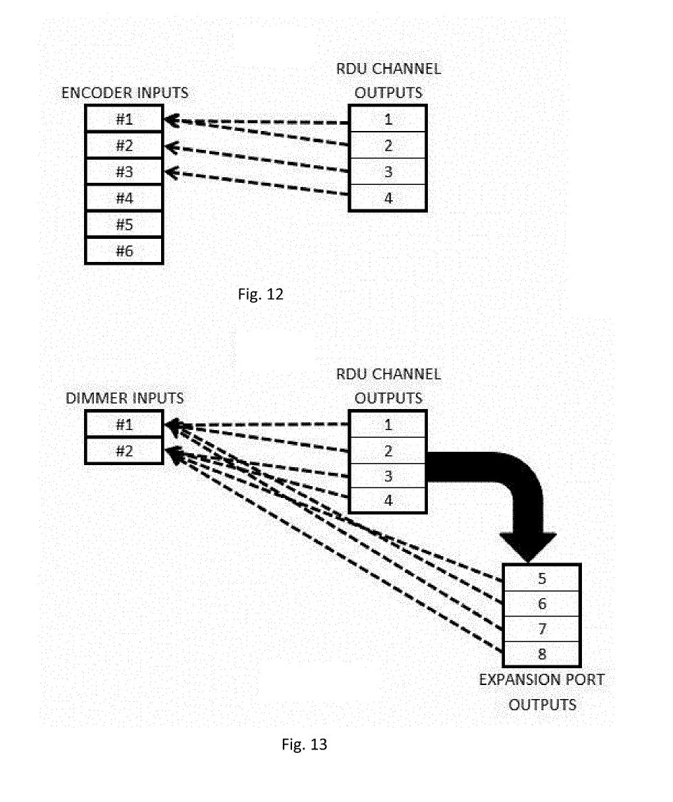

FIG. 12 illustrates a schematic of an encoder module utilized with a DC power controller. Each encoder module setting illustrates a virtual signal input module. Encoder module setting 1 is being utilized to control power channel output 1 and 2. Encoder module setting 2 is being utilized to control power channel output 3. Encoder module setting 3 is being utilized to control power channel output 4.

FIG. 13 illustrates two different signal input modules being used to control channel outputs in DC power controller in association with an expansion module. Signal input module 1, labeled dimmer input 1 is configured to control power output channels 1, 2, 6 and 7. Signal input module 2, labeled dimmer input 2, is being utilized to control power output channels 3, 4, 5 and 8.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

1. A DC power controller, wherein said DC power controller comprises:
at least one DC power input;
a plurality of DC power output channels for the output of DC power;
at least two power regulators configured to separately regulate the DC power output of two or more of said DC power output channels, wherein said power regulators are located between said power input and said plurality of DC power output channels;
at least one processor configured to control the DC power output according to a series of user defined power output curves stored in said DC power controller, wherein said user defined power output curves are configured such that power output in each channel in said series of DC power output channels is calculated by said processor using a single input signal from a signal input module; and
at least one signal input module connector configured to facilitate signal communication between a signal input module and said processor.

2. The DC power controller of claim 1, wherein said DC power controller further comprises at least one signal input module in connection with said signal input module connector and configured to provide user input signal to said processor as to the position on said user defined power output curves said processor is to utilize in calculating the DC power output per DC power output channel of the DC power controller.

2. (canceled)

3. The DC power controller of claim 2, wherein said signal input module comprises a potentiometer.

4. The DC power controller of claim 2, wherein said signal input module comprises an encoder module, wherein said encoder module comprises a plurality of virtual signal input modules, wherein said encoder module comprises the following:
a signal adjustment mechanism for adjusting a signal output from said encoder module to said processor; and
a selection mechanism configured to select the virtual signal input module for which said processor is utilizing to adjust the DC power output to each DC power output channel.

5. The DC power controller of claim 1, wherein a light is connected to at least one of said DC power output channels, wherein said DC power controller is configured to regulate the DC power output of said DC power controller to said DC power output channel connected to said light, wherein said DC power controller is configured such that changes in user signal input to said processor changes the lumen output of said light.

6. The DC power controller of claim 1, wherein a DC power output channel is connected to one or more of a incandescent light, a LED light, a heater pad, and a blower motor.

7. The DC power controller of claim 2, where said signal input module comprises a sensor.

8. The DC power controller of claim 7, wherein said sensor comprises a sensor configured to sense when a door opens and/or closes.

9. The DC power controller of claim 1, wherein a first DC power output channel is connected to one or more day lights, wherein a second DC power output channel is connected to a one or more night vision compatible lights, wherein said processor is configured to supply power to said one or more white lights and not to supply power to said one or more night vision compatible lights upon receiving a first signal from a signal input module, wherein said processor is configured to supply power to said one or more night vision compatible lights and not to supply power to said one or more white lights upon receiving a second signal from said signal input module.

10. The DC power controller of claim 2, wherein said signal input module comprises a switch.

11. The DC power controller of claim 2, wherein said DC power controller is located in a vehicle, wherein said signal input module comprises a vehicle ignition sensor.

12. The DC power controller of claim 1, wherein a first DC power output channel is connected to one or more incandescent lights, wherein a second DC power output channel is connected to one or more LED lights, wherein said processor is configured to control power to said incandescent light and to said LED in response to a first signal from a signal input module such that light output from said incandescent light and said LED light are the same, wherein said processor is configured to control power to said incandescent light and to said LED in response to a second signal from said signal input module such that light output from said incandescent light and said LED light are the same.

13. The DC power controller of claim 1, wherein said user defined power output curves comprise a curve defining the DC power output of a DC power output channel in response to a first signal from a signal input module connected to said signal input module connector, wherein said user defined power output curves define said DC power output of said DC power output channel in response to a second signal from said signal input module.

14. The DC power controller of claim 1, wherein said processor comprises an input threshold mode, wherein when said processor is in said input threshold mode said processor is configured to allow the output of the same amount of power in response to variations in signal from a signal input module connected to said signal input module connector that are less than a signal variations sufficient to cause the processor to utilize a different calibration point on the user defined output curve.

15. The DC power controller of claim 1, wherein said processor comprises a first signal input module connector and a second signal input module connector, wherein said processor is configured to control power output to a first power DC power output channel and a second DC power output channel in response to a signal from a signal input module connected to said first signal input module connector, wherein said processor is configured to control power output to a third DC power output channel and a fourth DC power output channel in response to a signal from a signal input module connected at said second signal input module connector.

16. The DC power controller of claim 1, wherein said processor comprises a first signal input module connector and a second signal input module connector, wherein said processor is configured to control power output to a first DC power output channel and a second DC power output channel in response to a signal from a signal input module connected to said first signal input module connector, wherein said processor is configured to control power output to a third DC power output channel and a fourth DC power output channel in response to a signal from a signal input module connected to said second signal input module connector.

17. The DC power controller of claim 1, wherein said DC power controller comprises a display module, wherein said processor is configured to display via the display module the total power consumed for each of said DC power output channels.

18. The DC power controller of claim 1, wherein said DC power controller comprises a first signal input module and a second signal input module, wherein said first signal input module is configured to adjust the DC power output to two or more of said DC power output channels in response to a first user defined power output curve, wherein said second signal input module is configured to adjust the DC power output to two or more of said DC power output channels in response to a second user defined power output curve.

19. A method of using a DC power controller, wherein said method comprises the following steps:
the step of providing a DC power controller, said DC power controller comprising:
at least one DC power input;
a plurality of DC power output channels comprising a series of DC power output channels;
at least one power regulator configured to regulate the DC power output of the DC power output channels and located between said power input and said plurality of DC power output channels;
at least one processor configured to control DC power controller DC power output wherein said user defined power output curves are configured such that power output in each DC power output channel in said series of DC power output channels is determined by a single user input; and
at least one signal input module configured for a user to provide an input signal to said processor as to the location on said user defined power output curve from which the processor is to calculate power output for each DC power output channel;
the step of programming a user defined power output curve into said DC power controller by assigning a power output value to a first DC power output channel in response to a first signal input from said signal input module and a power output value to a second DC power output channel at said first signal input from said signal input module and by assigning a power output value to said first DC power output channel at a second input signal from said signal input module and a power output value to a second DC power output channel at said second signal input from said signal input module.

20. The method of using a DC power controller of claim 19, wherein said step of providing a DC power controller further comprises providing a plurality of user defined power output curves and providing a mechanism for a user to select which power output curve is utilized by said processor in regulating the DC power output to the plurality of DC power output channels in response to an input signal.
